(19) United States
(12) Patent Application Publication
(10) Pub. No.: US 2026/0337824 A1
(43) Pub. Date: Oct. 29, 2026

(54) MXENE COMPOSITE FIBERS AND MANUFACTURING METHOD THEREOF

(71) Applicants: Hyundai Motor Company, Seoul (KR); Kia Corporation, Seoul (KR); Industry-University Cooperation Foundation Hanyang University, Seoul (KR)

(72) Inventors: Hong Chan Jeon, Seoul (KR); Sang Soo Jeon, Anyang (KR); Hyun Dae Cho, Anyang (KR); Jee Jung Kim, Yongin (KR); So La Chung, Seoul (KR); Jin Ho Hwang, Cheonan (KR); Tae Hee Han, Seoul (KR); Woo Jae Jeong, Seoul (KR); Dong Jun Kang, Seoul (KR); Hwan Soo Shin, Seoul (KR)

(21) Appl. No.: 19/713,587

(22) Filed: Jun. 18, 2026

Related U.S. Application Data
(62) Division of application No. 18/385,252, filed on Oct. 30, 2023.

(30) Foreign Application Priority Data
May 17, 2023 (KR) 10-2023-0063872

(51) Int. Cl. D01D 5/06; D01D 1/02; D01D 4/02; D01D 5/084; D01F 8/08; D01F 8/18

(52) U.S. Cl. CPC D01D 5/06; D01D 1/02; D01D 4/02; D01D 5/084; D01F 8/08; D01F 8/18

(57) ABSTRACT

Disclosed are a composite fiber (MXene composite fiber) and a manufacturing method thereof. The composite fibers are manufactured by braiding a MXene-PAN fiber heat-treated with a polymer fiber. The method includes preparing a first dispersion including an MXene compound and a first solvent, preparing a second dispersion including polyacrylonitrile (PAN) and a second solvent, obtaining an admixture including the first dispersion and the second dispersion, obtaining a spun fiber by performing wet-spinning of the admixture, obtaining an MXene-PAN fiber by performing heat treatment of the spun fiber, and obtaining the MXene composite fiber by braiding the MXene-PAN fibers with a polymer fiber. An electrical conductivity of the MXene-PAN fiber is about 0.1 Scm⁻¹ to 1,000 Scm⁻¹.

### CROSS-REFERENCE TO RELATED APPLICATION

This application claims under 35 U.S.C. § 119 (a) the benefit of priority to Korean Patent Application No. 10-2023-0063872 filed on May 17, 2023, the entire contents of which are incorporated herein by reference.

### TECHNICAL FIELD

The present disclosure relates to a composite fiber (“MXene composite fiber”) and a method of manufacturing the same.

### BACKGROUND

MXene compounds are a class of novel two-dimensional compounds having a high electrical conductivity and electrochemical characteristics similar to metals. MXenes show excellent performance in many fields, such as electrochemical energy storage devices, electrodes, gas and moisture sensors, conductive fillers, and the like.

Further, the MXene compounds have excellent dispersibility due to hydrophilic functional groups (OH, O, F) on the surfaces thereof. Therefore, a highly dispersed MXene solution may be manufactured into fibers. However, the manufactured fiber structures have poor mechanical properties and very low oxidation stability, compared to excellent performance of one MXene sheet.

Therefore, in order to use MXene compounds in electric wires, electrothermal and heating materials, wearable electronic materials, and the like, MXene compounds may require further improved chemical stability and mechanical properties.

The above information disclosed in this Background section is only for enhancement of understanding of the background of the disclosure and therefore it may contain information that does not form the prior art that is already known in this country to a person of ordinary skill in the art.

### SUMMARY

In preferred aspects, provided are a composite fiber (“MXene composite fiber”) having improved mechanical properties and oxidation stability and a manufacturing method thereof.

In one aspect, a method of manufacturing a composite fiber is provided that may suitably comprise: a) preparing a first dispersion comprising an MXene compound and a first solvent; b) preparing a second dispersion comprising polyacrylonitrile (PAN) and a second solvent; c) obtaining an admixture comprising the first dispersion and the second dispersion; d) obtaining MXene-PAN fiber using the admixture; and e) obtaining the composite fiber that comprises the MXene-PAN fiber and polymer fiber, wherein an electrical conductivity of the MXene-PAN fiber is about 0.1 Scm⁻¹ to 1,000 Scm⁻¹. In certain embodiments, a spun fiber is obtained by performing wet-spinning of the admixture; and/or a MXene-PAN fiber is obtained by performing heat treatment of the spun fibers; and/or the composite fiber is obtained by braiding the MXene-PAN fiber with a polymer fiber.

In one preferred aspect, the present disclosure provides a method of manufacturing a composite fiber. The method includes steps of: preparing a first dispersion including an MXene compound and a first solvent, preparing a second dispersion including polyacrylonitrile (PAN) and a second solvent, obtaining an admixture including the first dispersion and the second dispersion, obtaining a spun fiber by performing wet-spinning of the admixture, obtaining a MXene-PAN fiber by performing heat treatment of the spun fiber, and obtaining the composite fiber by braiding the MXene-PAN fiber with a polymer fiber.

The MXene compound is represented by Formula (I)

Mₙ₊₁XₙTₓ (I)
wherein M is an early transition metal, X is C or N, Tₓ is a surface termination, and n is an integer of 1 to 4. In certain embodiments, M may suitably include one or more selected from Sc, Ti, V, Cr, Mn, Y, Zr, Nb, Mo, Tc, Lu, Hf, Ta, W, Re, LR, Rf, Db, Sg, Bh, and the like. In certain embodiments, Tₓ may suitably include a functional group such a —F, —O, or —OH, but the limitations are not limited thereto.

In particular, an electrical conductivity of the MXene-PAN fibers is 0.1 Scm⁻¹ to 1,000 Scm⁻¹.

The first solvent may suitably include one or more selected from the group consisting of 1-methyl-2-pyrrolidinone-N-methyl-2-pyrrolidinone (NMP), N,N-dimethylformamide (DMF), dimethylacetamide (DMAc), and dimethyl sulfoxide (DMSO).

A concentration of the MXene compound in the first dispersion may be about 10 mg/mL to 45 mg/mL.

The second solvent may include one or more selected from the group consisting of 1-methyl-2-pyrrolidinone-N-methyl-2-pyrrolidinone (NMP), N,N-dimethylformamide (DMF), dimethylacetamide (DMAc), and dimethyl sulfoxide (DMSO).

A concentration of the PAN in the second dispersion may be about 50 mg/mL to 500 mg/mL.

The spun fiber may include an amount of about 10 wt % to 50 wt % of the MXene compound based on a total weight of the spun fiber.

In obtaining the spun fiber, the spun fiber may be obtained by wet-spinning the admixture into a coagulation solution, and the coagulation solution may suitably include one or more selected from the group consisting of water, acetone, methyl alcohol, ethyl alcohol, isopropyl alcohol, methyl acetate, ethyl acetate, propyl acetate, acetic acid, acetonitrile, 1-methyl-2-pyrrolidinone-N-methyl-2-pyrrolidinone (NMP), N,N-dimethylformamide (DMF), dimethylacetamide (DMAc), dimethyl sulfoxide (DMSO), and tetrahydrofuran (THF).

A temperature of the coagulation solution may be about 20 °C to 60 °C.

The wet-spinning may be performed using a spinneret having a diameter of about 10 μm to 1,500 μm.

The heat treatment may be performed at a temperature of about 300 °C to 500 °C.

The heat treatment may be performed at a heating rate of about 1 to 20 °C min⁻¹ for about 30 to 90 minutes.

The MXene-PAN fiber may have a fiber structure including a base material including the PAN. The MXene may be distributed in the base material.

The MXene-PAN fiber may suitably include an amount of about 10 wt % to 50 wt % of the MXene compound based on a total weight of the MXene-PAN fiber.

The polymer fiber may suitably include one or more selected from the group consisting of a polyethylene-based polymer, an aramid-based polymer, a nylon-based polymer, a cellulose-based polymer, polyethylene terephthalate, polyvinyl alcohol, polycarbonate, polypropylene, polyamic acid, polyimide, polyvinylidene fluoride, polyacrylonitrile, polystyrene, and polyvinyl chloride.

In another aspect, the present disclosure provides a composite fiber manufactured by the method described herein.

In another aspect, the present disclosure provides a composite fiber including a base material including polyacrylonitrile (PAN), the MXene compound represented by Formula (I) as described herein, and the polymer fiber as described herein. The MXene compound and PAN form an MXene-PAN fiber, and the MXene compound is distributed in the base material. The MXene-PAN fiber may suitably include an amount of about 10 wt % to 50 wt % of the MXene compound based on a total weight of the MXene-PAN fibers.

The polymer fiber may suitably one or more selected from the group consisting of a polyethylene-based polymer, an aramid-based polymer, a nylon-based polymer, a cellulose-based polymer, polyethylene terephthalate, polyvinyl alcohol, polycarbonate, polypropylene, polyamic acid, polyimide, polyvinylidene fluoride, polyacrylonitrile, polystyrene, and polyvinyl chloride.

In still another aspect, the present disclosure provides a heating element including a plurality of heating wires. Each of the heating wire includes the composite fiber as described herein.

The heating element may be a thread which is a bundle made from the plurality of the heating wires.

In a further aspect, the present disclosure provides a wearable product including the heating element, or the thread as described herein.

Other aspects and preferred embodiments of the disclosure are discussed infra.

### BRIEF DESCRIPTION OF THE DRAWINGS

The above and other features of the present disclosure will now be described in detail with reference to certain exemplary embodiments thereof illustrated in the accompanying drawings which are given hereinbelow by way of illustration only, and thus are not limitative of the present disclosure, and wherein:

FIG. 1 an exemplary method of an MXene composite fibers according to an exemplary embodiment of the present disclosure;

FIG. 2 is a graph showing X-ray photoelectron spectroscopy (XPS) spectra of MXene-polyacrylonitrile (PAN) fibers manufactured depending on heat treatment conditions;

FIG. 3 is a graph showing thermogravimetric analysis (TGA) curves of the MXene-PAN fibers manufactured depending on heat treatment conditions;

FIG. 4 is a graph showing electrical conductivity values of MXene-PAN fibers having various MXene contents before and after heat treatment;

FIG. 5 shows an exemplary planar heating element manufactured by applying the MXene-PAN fibers according to an exemplary embodiment of the present disclosure, and heat generation temperatures of the planar heating element;

FIG. 6 is a graph showing temperature changes of the planar heating element over time;

FIG. 7 is a graph showing power densities of the planar heating element depending on temperature changes;

FIG. 8A is a view showing MXene composite fibers manufactured by applying the MXene-polyacrylonitrile fibers according to an exemplary embodiment of the present disclosure;

FIG. 8B is an enlarged photograph of the MXene composite fibers;

FIG. 9A is a photograph showing resistance of the MXene composite fibers before bending;

FIG. 9B is a photograph showing resistance of the MXene composite fibers after bending;

FIG. 10A is a view schematically showing an apparatus for measuring stabilities of the MXene composite fibers;

FIG. 10B is a view showing a method of measuring the stabilities of the MXene composite fibers;

FIGS. 11A and 11B are views showing results of heat resistance evaluation of the MXene composite fibers;

FIGS. 12A and 12B are views showing results of heat resistance evaluation of the MXene composite fibers depending on humidity; and

FIG. 13 is a view showing results of heat resistance evaluation of the MXene composite fibers with respect to a high temperature.

### DETAILED DESCRIPTION

The above-described objects, other objects, advantages and features of the present disclosure will become apparent from the descriptions of embodiments given hereinbelow with reference to the accompanying drawings. However, the present disclosure is not limited to the embodiments disclosed herein and may be implemented in various different forms. The embodiments are provided to make the description of the present disclosure thorough and to fully convey the scope of the present disclosure to those skilled in the art.

In the following description of the embodiments, the same elements are denoted by the same reference numerals even when they are depicted in different drawings. In the drawings, the dimensions of structures may be exaggerated compared to the actual dimensions thereof, for clarity of description. In the following description of the embodiments, terms, such as “first” and “second”, may be used to describe various elements but do not limit the elements. These terms are used only to distinguish one element from other elements. For example, a first element may be named a second element, and similarly, a second element may be named a first element, without departing from the scope and spirit of the disclosure. Singular expressions may encompass plural expressions, unless they have clearly different contextual meanings.

In the following description of the embodiments, terms, such as “including”, “comprising” and “having”, are to be interpreted as indicating the presence of characteristics, numbers, steps, operations, elements or parts stated in the description or combinations thereof, and do not exclude the presence of one or more other characteristics, numbers, steps, operations, elements, parts or combinations thereof, or possibility of adding the same. In addition, it will be understood that, when a part, such as a layer, a film, a region or a plate, is said to be “on” another part, the part may be located “directly on” the other part or other parts may be interposed between the two parts. In the same manner, it will be understood that, when a part, such as a layer, a film, a region or a plate, is said to be “under” another part, the part may be located “directly under” the other part or other parts may be interposed between the two parts.

All numbers, values and/or expressions representing amounts of components, reaction conditions, polymer compositions and blends used in the description are approximations in which various uncertainties in measurement generated when these values are obtained from essentially different things are reflected and thus it will be understood that they are modified by the term “about”, unless stated otherwise. Further, unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

In addition, it will be understood that, if a numerical range is disclosed in the description, such a range includes all continuous values from a minimum value to a maximum value of the range, unless stated otherwise. Further, if such a range refers to integers, the range includes all integers from a minimum integer to a maximum integer, unless stated otherwise. In the present specification, when a range is described for a variable, it will be understood that the variable includes all values including the end points described within the stated range. For example, the range of “5 to 10” will be understood to include any subranges, such as 6 to 10, 7 to 10, 6 to 9, 7 to 9, and the like, as well as individual values of 5, 6, 7, 8, 9 and 10, and will also be understood to include any value between valid integers within the stated range, such as 5.5, 6.5, 7.5, 5.5 to 8.5, 6.5 to 9, and the like. Also, for example, the range of “10% to 30%” will be understood to include subranges, such as 10% to 15%, 12% to 18%, 20% to 30%, etc., as well as all integers including values of 10%, 11%, 12%, 13% and the like up to 30%, and will also be understood to include any value between valid integers within the stated range, such as 10.5%, 15.5%, 25.5%, and the like.

The present disclosure relates to a manufacturing method of MXene composite fibers. Hereinafter, the present disclosure will be described in more detail with reference to the accompanying drawings.

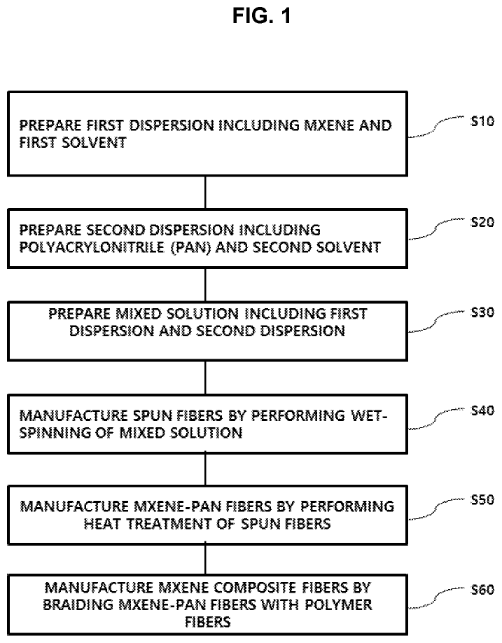

FIG. 1 shows an exemplary manufacturing method of the MXene composite fiber according to an exemplary embodiment of the present disclosure.

As shown in FIG. 1, the manufacturing method of the MXene composite fibers according to an exemplary embodiment of the present disclosure includes preparing a first dispersion including an MXene compound and a first solvent (S10), preparing a second dispersion including polyacrylonitrile (PAN) and a second solvent (S20), obtaining a admixture including the first dispersion and the second dispersion (S30), obtaining a spun fiber by performing wet-spinning of the admixture (S40), obtaining a MXene-PAN fiber by performing heat treatment of the spun fiber (S50), and obtaining the MXene composite fiber by braiding the MXene-PAN fiber with a polymer fiber (S60). The electrical conductivity of the MXene-PAN fibers used in Operation S60 of the present disclosure is about 0.1 Scm⁻¹ to 1,000 Scm⁻¹.

Preferably, the MXene compound is represented by Formula (I)

Mₙ₊₁XₙTₓ (I)
wherein M is an early transition metal, X is C or N, Tₓ is a surface termination, and n is an integer of 1 to 4.

In certain embodiments, M may suitably include one or more selected from Sc, Ti, V, Cr, Mn, Y, Zr, Nb, Mo, Tc, Lu, Hf, Ta, W, Re, LR, Rf, Db, Sg, Bh, and the like.

In certain embodiments, Tₓ may suitably include a functional group such a —F, —O, or —OH, but the limitations is not limited thereto.

Hereinafter, the respective Operations of the manufacturing method according to the present disclosure will be described in detail.

First, in Operation S10, the first dispersion is prepared by mixing the MXene compound and the first solvent.

The concentration of the MXene compound in the first dispersion may be about 10 mg/mL to 45 mg/mL. When the concentration of MXene in the first dispersion is less than about 10 mg/mL, a admixture having a low viscosity may be obtained by mixing the first dispersion and the second dispersion including PAN and thus spinnability of the admixture may be reduced, and, when the concentration of MXene in the first dispersion is greater than about 45 mg/mL, agglomeration between MXene and PAN occurs, and spinnability of the admixture may be reduced due to the high viscosity of the admixture.

MXene compounds may have excellent dispersibility in water due to hydrophilic functional groups (OH, O, F) on the surface thereof. However, when the MXene compound is dispersed in water at a high concentration, it is actually difficult to use an obtained dispersion. The reason for this is that it is difficult to redisperse MXene compounds in water. Further, nano sheets in MXene agglomerate together, and thus, it is difficult to produce a uniform dispersion. Therefore, in the present disclosure, the first solvent may employ an organic solvent.

The first solvent may suitably include one or more selected from the group consisting of 1-methyl-2-pyrrolidinone-N-methyl-2-pyrrolidinone (NMP), N,N-dimethylformamide (DMF), dimethylacetamide (DMAc), and dimethyl sulfoxide (DMSO).

Thereafter, in Operation S20, the second dispersion is prepared by mixing polyacrylonitrile (PAN) and the second solvent.

The concentration of PAN in the second dispersion may be about 50 mg/mL to 500 mg/mL. When the concentration of PAN in the second dispersion is less than about 50 mg/mL, the admixture may not be coagulated, and, when the concentration of PAN in the second dispersion is greater than about 500 mg/mL, uniform spinning may not be carried out due to high conductivity of the admixture.

PAN is not dispersed in water, and thus, the second solvent may employ an organic solvent.

The second solvent may include one or more selected from the group consisting of 1-methyl-2-pyrrolidinone-N-methyl-2-pyrrolidinone (NMP), N,N-dimethylformamide (DMF), dimethylacetamide (DMAc), and dimethyl sulfoxide (DMSO).

Thereafter, in Operation S30, the admixture is prepared by mixing the first dispersion and the second dispersion.

When the organic solvent is used as solvents for both the first dispersion and the second dispersion, the admixture is stable at a high concentration, and thus, a uniform admixture may be obtained without agglomeration of MXene. Further, MXene particles dispersed in the organic solvent have high affinity with the solution including PAN due to the functional groups on the surfaces of the MXene particles, and thereby, a stable admixture may be obtained. That is, a spinning solution having excellent stability and a high concentration may be manufactured, and a admixture having high oxidation stability may be obtained.

Thereafter, in Operation S40, the spun fibers may be manufactured using wet-spinning of the admixture.

In Operation S40, the spun fibers may be obtained by wet-spinning the admixture into a coagulation solution. Here, the spun fibers may include an amount of about 10 wt % to 50 wt % of the MXene compound based on the total weight of the spun fiber.

In wet-spinning according to an exemplary embodiment of the present disclosure, for example, the admixture is spun into the coagulation solution through a spinneret (nozzle) by applying pressure to the admixture, and the admixture is solidified due to diffusion of the solvent into the coagulation solution to form fibers.

The admixture may be spun at a rate of about 0.1 mL/h to 35 mL/h. When the spinning rate is greater than about 35 mL/h, uniform shear stress is not applied to the admixture, and thereby, non-uniform fibers may be spun.

In the present disclosure, the term “coagulation bath” means a liquid bath configured to coagulate the spun solution.

The coagulation solution may include one or more selected from the group consisting of water, acetone, methyl alcohol, ethyl alcohol, isopropyl alcohol, methyl acetate, ethyl acetate, propyl acetate, acetic acid, acetonitrile, 1-methyl-2-pyrrolidinone-N-methyl-2-pyrrolidinone (NMP), N,N-dimethylformamide (DMF), dimethylacetamide (DMAc), dimethyl sulfoxide (DMSO), and tetrahydrofuran (THF). For example, the coagulation solution may include water and ethyl alcohol in a volume ratio of about 3:7 to 7:3.

The temperature of the coagulation solution may be about 20 °C to 60 °C. When the temperature of the coagulation solution is lower than about 20 °C, the coagulation rate of the admixture is slow and thus the properties of the spun fibers may be reduced due to irregular contraction during a remaining solution drying process, and, when the temperature of the coagulation solution is higher than about 60 °C, the solvent rapidly escapes from the surfaces of the fibers due to increase of the diffusion rate of the solvent and is coagulated, and thus, the solvent may remain in the fibers and the properties of the fibers may be deteriorated.

In wet-spinning, the spinneret having a diameter of about 10 μm to 1,500 μm may be used. For example, the diameter of the spinneret may be about 100 μm to 1,000 μm, about 100 μm to 500 μm, or preferably about 100 μm to 410 μm. When the diameter of the spinneret is less than about 100 μm, spinning through the nozzle may not performed, and when the diameter of the spinneret is greater than about 1,500 μm, orientation and density of the fibers are lowered due to an insufficient shear stress, and thus, mechanical properties of the fibers may be deteriorated.

Operation S40 may further include drawing the spun fibers manufactured by wet-spinning the admixture.

The spun fibers may be drawn for 1 to 20 times. A degree of alignment of MXene nano-sheets and PAN particles in the axial direction of the fibers, i.e., the orientation of the fibers, may be improved through drawing.

Thereafter, in Operation S50, the MXene-PAN fibers are manufactured by performing heat treatment of the spun fibers.

Operation S50 may be performed in an inert gas atmosphere, and the inert gas may include argon, nitrogen, and the like.

In Operation S50, the heat treatment causes cyclization and carbonization of PAN, and thus, the mechanical properties of the fibers may be enforced.

Further, some of the functional groups on the surfaces of the MXene nano sheets are removed through the heat treatment, and thus, oxidation stability by water is improved, and the distance between the nano-sheets is decreased. Thereby, the hopping distance of electrons is reduced, and thus, the electrical properties of the fibers may be improved. Further, the decreased distance between the nano-sheets increases the density of the fibers, and thus, the mechanical properties of the fibers may be improved.

The heat treatment may be performed at a temperature of about 300 °C to 500 °C. When the heat treatment temperature is lower than about 300 °C, cyclization of PAN is not performed and thus the electrical properties and the mechanical properties of the fibers may be deteriorated, and, when the heat treatment temperature is higher than about 500 °C, a normal cyclization reaction product may not be obtained due to carbonization of PAN.

The heat treatment may be performed at a heating rate of about 1 to 20 °C min⁻¹ for about 30 to 90 minutes.

The MXene-PAN fibers obtained through the heat treatment in Operation S50 may have electrical conductivity of about 0.1 Scm⁻¹ to 1,000 Scm⁻¹.

Further, the MXene-PAN fibers include a first base material including PAN and having the shape of fibers, and the MXene compound is distributed in the first base material. Here, the MXene-PAN fibers may include an amount of about 10 wt % to 50 wt % of MXene based on the total weight of the MXene-PAN fibers. Here, when the content of MXene compound in the MXene-PAN fibers is less than about 10 wt %, a admixture having a low viscosity may be obtained by mixing the first dispersion including MXene compound and the second dispersion including polyacrylonitrile and thus spinnability of the admixture may be reduced, and, when the content of MXene in the MXene-PAN fibers is greater than about 50 wt %, agglomeration between MXene and PAN occurs, and spinnability of the admixture may be lowered due to the high viscosity of the admixture.

Finally, in Operation S60, the MXene composite fibers, i.e., a final product, may be manufactured by braiding the MXene-PAN fibers with the polymer fibers.

In the present disclosure, the polymer fibers may have stable electrical resistance to external stimuli, such as bending, twisting, and the like.

Concretely, the polymer fibers may include one or more selected from the group consisting of polyethylene-based polymers, aramid-based polymers, nylon-based polymers, cellulose-based polymers, polyethylene terephthalate, polyvinyl alcohol, polycarbonate, polypropylene, polyamic acid, polyimide, polyvinylidene fluoride, polyacrylonitrile, polystyrene, and polyvinyl chloride.

In another aspect, the present disclosure relates to composite fibers (“MXene composite fibers”) manufactured by the above manufacturing method.

The MXene composite fibers according to the present disclosure may be manufactured by braiding the MXene-PAN fibers with the polymer fibers.

The electrical conductivity of the MXene-PAN fibers is 0.1 Scm⁻¹ to 1,000 Scm⁻¹.

The MXene-PAN fiber includes a base material including PAN and having the shape of fibers, and the MXene compound distributed in the base material, and the MXene-PAN fibers may include an amount of about 10 wt % to 50 wt % of the MXene compound based on the total weight of the MXene-PAN fibers.

The polymer fibers may include one or more selected from the group consisting of polyethylene-based polymers, aramid-based polymers, nylon-based polymers, cellulose-based polymers, polyethylene terephthalate, polyvinyl alcohol, polycarbonate, polypropylene, polyamic acid, polyimide, polyvinylidene fluoride, polyacrylonitrile, polystyrene, and polyvinyl chloride.

Table 1 below represents measured electrical conductivity values of the MXene-PAN fibers depending on MXene content in the MXene-PAN fibers and heat treatment conditions.

TABLE 1

| Additional | | Electrical |
|---|---|---|
| treatment | | conductivity |
| process | Fiber | (Scm⁻¹) |
| 80 °C drying | MXene-PAN (MXene 10 wt %) | 0.06 ± 0.00 |
| and heat setting | MXene-PAN (MXene 20 wt %) | 5.10 ± 0.32 |
| | MXene-PAN (MXene 30 wt %) | 30.15 ± 0.81 |
| | MXene-PAN (MXene 40 wt %) | 98.16 ± 7.81 |
| | MXene-PAN (MXene 50 wt %) | 324.20 ± 8.25 |
| 500 °C annealing | MXene-PAN (MXene 10 wt %) | 0.10 ± 0.00 |
| in Ar condition | MXene-PAN (MXene 20 wt %) | 9.29 ± 0.18 |
| | MXene-PAN (MXene 30 wt %) | 44.69 ± 1.50 |
| | MXene-PAN (MXene 40 wt %) | 167.89 ± 3.26 |
| | MXene-PAN (MXene 50 wt %) | 489.58 ± 32.59 |

As shown in Table 1, as the MXene content in the MXene-PAN fibers increases, the electrical conductivity of the MXene-PAN fibers increases.

Further, as set forth in Table 1, the electrical conductivity of the MXene-PAN fibers according to the present disclosure is 0.1 Scm⁻¹ to 1,000 Scm⁻¹.

Although the MXene composite fibers have no limits on the field of use thereof, the MXene composite fibers may be applied to wearable fiber materials, electric wires, and heating wires. Further, the MXene composite fibers may be applied to fields, such as cars, aircraft, and various cable and electric heating products.

Therefore, the present disclosure relates to a heating element. The heating element according to the present disclosure includes heating wires including the MXene composite fibers, and the heating wires have the shape of fibers.

The heating element may be a thread which is a bundle made from the heating wires.

Further, the present disclosure relates to a wearable product. The wearable product according to the present disclosure includes the thread, or is woven from the thread.

### EXAMPLE

Hereinafter, the present disclosure will be described in more detail through the following examples. The following examples serve merely to exemplarily describe the present disclosure, and are not intended to limit the scope of the disclosure.

### Manufacturing Example 1: Preparation of Mixed Solutions

First, spun fibers were obtained by preparing mixed solutions having adjusted MXene contents and then performing wet-spinning of the mixed solutions.

For example, the preparation method and the spinning conditions of the mixed solutions are as follows.

First, mixing solutions having different MXene contents were prepared by mixing a first dispersion including MXene and dimethyl sulfoxide and having a MX concentration 10 mg/mL to 45 mg/mL and a second dispersion including polyacrylonitrile (PAN) and dimethyl sulfoxide and having a PAN concentration of 50 mg/mL to 500 g/mL.

Subsequently, spun fibers were obtained by injecting the respective mixed solutions obtained according to Mixed Solution Manufacturing Example into a plastic syringe provided with a spinneret having a diameter of 100 μm, and spinning the mixed solutions into a coagulation bath at a rate of 15 mL/h using an injection pump. Here, the temperature of a coagulation solution in the coagulation bath was 20 °C, and the coagulation solution was a mixed solution including water and ethyl alcohol in a volume ratio of 3:7.

The obtained spun fibers according to Mixed Solution Manufacturing Example were dried by a drying heater at a temperature of 60 °C, and were additionally dried for the purpose of heat setting. Here, the MXene contents in the manufactured spun fibers were 10 to 50 wt %.

### Manufacturing Example 2: Manufacture of MXene-PAN Fibers

Subsequently, MXene-PAN fibers were manufactured according to Heat Treatment Examples by performing heat treatment of the spun fibers according to Mixed Solution Manufacturing Example at temperatures set forth in Table 2 below and a heating rate of 5 °C min⁻¹ for 1 hour, while fixing both ends of the fibers in an Ar atmosphere so as to prevent contraction of the fibers. Here, the MXene contents in the manufactured MXene-PAN fibers were 10 to 50 wt %.

TABLE 2

| Mixed solution | Heat treatment |
|---|---|
| manufacturing example | temperature |
| Heat treatment example 1 | 400 °C |
| Heat treatment example 2 | 500 °C |
| Heat treatment example 3 | 600 °C |

### Test Example 1: Characteristics of MXene-PAN Fibers Depending on MXene Content and Heat Treatment Temperature

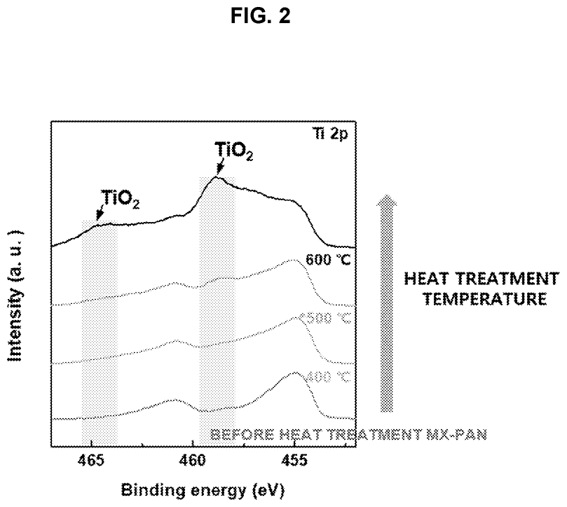

First, in order to find out the characteristics of the manufactured MXene-PAN fibers depending on heat treatment temperature, results of X-ray photoelectron spectroscopy (XPS) spectra of the MXene-PAN fibers manufactured according to Heat Treatment Examples are shown in FIG. 2. Here, the MXene contents in the manufactured MXene-PAN fibers were 50 wt %.

FIG. 2 is a graph showing the X-ray photoelectron spectroscopy (XPS) spectra of the MXene-PAN fibers manufactured depending on heat treatment conditions.

As shown in FIG. 2, when the MXene-PAN fibers were manufactured through the heat treatment of the spun fibers at a temperature of 600 °C or higher, TiO₂, which is a nonconductive material, was generated by oxidation.

TiO₂ generated in the MXene-PAN fibers causes decrease in the electrical conductivity of the MXene-PAN fibers.

Such decrease in the electrical conductivity of the MXene-PAN fibers may reduce heat generation efficiency due to rise in applied voltage when heating fibers are used.

Therefore, when MXene is heat-treated, gas occurs due to detachment of the functional groups, and the gas generates micro-pores in the fibers and thus influences deterioration of the properties of the fibers. Further, an excessively low heating rate applies a large amount of heat to MXene and may thus contribute to oxidation of the insides of the fibers.

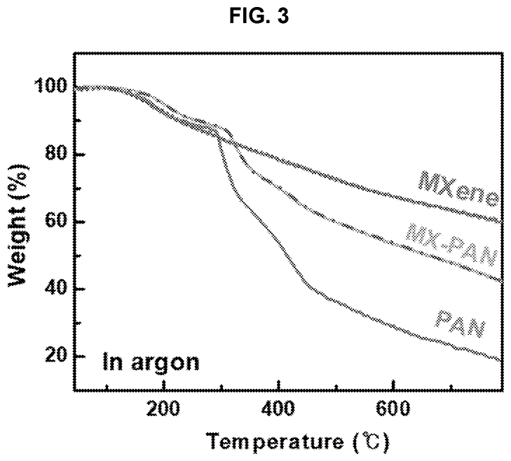

Results of thermogravimetric analysis (TGA) curves of the MXene-PAN fibers manufactured according to Heat Treatment Examples are shown in FIG. 3. Here, the MXene contents in the manufactured MXene-PAN fibers were 50 wt %.

FIG. 3 is a graph showing the thermogravimetric analysis (TGA) curves of the MXene-PAN fibers manufactured depending on heat treatment conditions.

As shown in FIG. 3, the phase of PAN was rapidly changed from a temperature of about 300 °C. The reason for such a phenomenon is that cyclization of polymer chains of PAN occurred at about 300 °C, and thereby, imparted the electrical properties to the MXene-PAN fibers and improved the mechanical properties of the MXene-PAN fibers.

Therefore, PAN is a non-conductive polymer, cyclization of the polymer chains of PAN did not occur at a temperature lower than 300 °C, and therefore, the MXene-PAN fibers did not have electrical conductivity and are not improved in the mechanical properties thereof. Therefore, in the present disclosure, the spun fibers should be heat-treated at a temperature of 300 °C to 500 °C and a heating rate of 1 to 20 °C min⁻¹.

### Test Example 2: Characteristics of MXene-PAN Fibers Depending on MXene Content and Heat Treatment

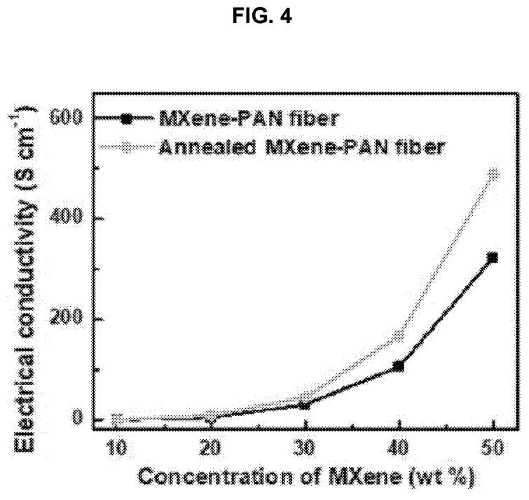

Next, in order to find out the characteristics of manufactured MXene-PAN fibers depending on MXene content and heat treatment, electrical conductivities of the MXene-PAN fibers before and after heat treatment were measured, and are shown in FIG. 4. Here, heat treatment conditions were a temperature of 500 °C.

FIG. 4 is a graph showing electrical conductivity values of MXene-PAN fibers having various MXene contents before and after heat treatment.

First, in manufacturing the MXene-polyacrylonitrile fibers, in case of a spinning solution having a MXene content of 60 wt % or greater, MXene was melted in a coagulation solution, and thus, it is impossible to form a gel.

As shown in FIG. 4, MXene-PAN fibers manufacturing by heat-treating spun fibers at a temperature of 500 °C exhibited improved mechanical and electrical properties due to cyclization and dehydrogenation of PAN, compared to MXene-PAN fibers manufactured without heat treatment of spun fibers.

### Manufacturing Example 3: Manufacture of Planar Heating Element by Applying MXene-PAN Fibers

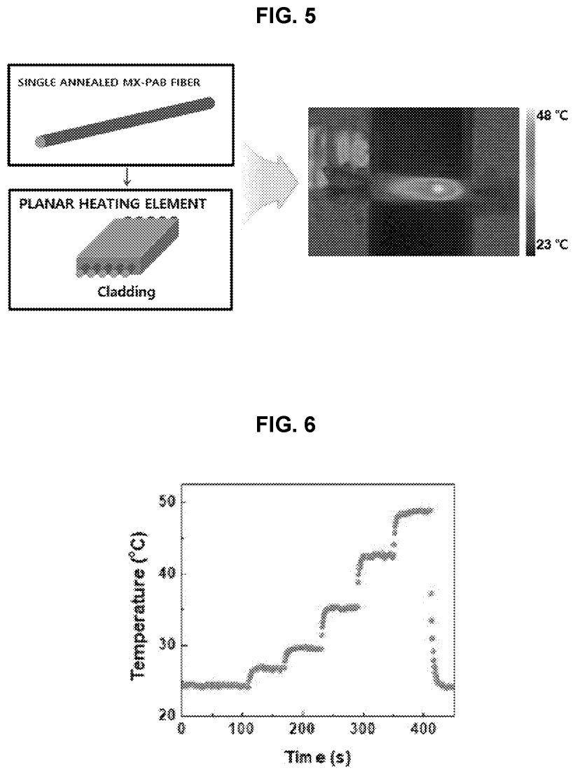

A planar heating element was manufactured by applying the MXene-PAN fibers according to Heat Treatment Example, as shown in FIG. 5. Here, FIG. 5 shows the planar heating element manufactured by applying the MXene-polyacrylonitrile fibers according to an exemplary embodiment of the present disclosure, and heat generation temperatures of the planar heating element.

### Test Example 3: Evaluation of Performance of Planer Heating Element

Performance of the manufactured planar heating element was confirmed by measuring temperature changes of the planar heating element over time and power densities of the planar heating element depending on temperature changes.

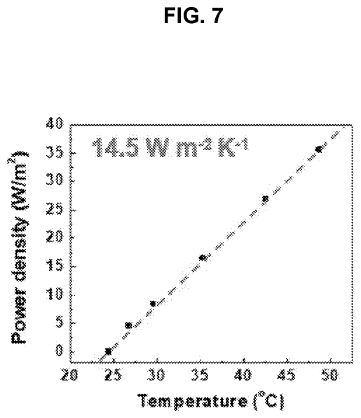

FIG. 6 is a graph showing the temperature changes of the planar heating element over time. FIG. 7 is a graph showing the power densities of the planar heating element depending on temperature changes.

Referring to FIGS. 6 and 7, it may be confirmed that the planar heating element manufactured by applying the MXene-polyacrylonitrile fibers according to the present disclosure generates heat at a temperature in the range of 20 °C to 50 °C, and had a power density of 14.5 W/m²K at this temperature.

### Manufacturing Example 4: Manufacture of MXene Composite Fibers

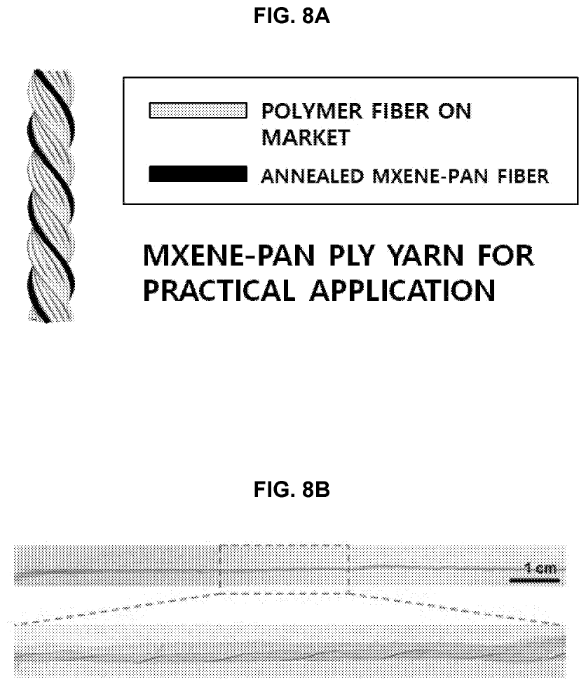

MXene composite fibers were manufactured by braiding the MXene-PAN fibers manufactured according to Heat Treatment Example with polymer fibers, as shown in FIG. 8A.

Here, FIG. 8A is a view showing the MXene composite fibers manufactured by applying the MXene-polyacrylonitrile fibers according to the present disclosure. FIG. 8B is an enlarged photograph of the MXene composite fibers.

The detailed manufacturing method of the MXene composite fibers are as follows.
1). Spun fibers were manufactured through wet-spinning of a mixed solution including MXene and polyacrylonitrile (PAN). Here, the detailed manufacturing method of the mixed solution is the same as the method in the above-described Mixed Solution Manufacturing Example.
2). MXene-PAN fibers having MXene contents of 10, 20, 30, 40, and 50 wt % were manufactured by performing heat treatment of the spun fibers at a temperature of 500 °C and a heating rate of 5 °C min⁻¹ for 1 hour.
3). MXene composite fibers were manufactured by braiding the manufactured MXene-PAN fibers with polymer fibers. Here, the used polymer fibers may include at least one selected from the group consisting of polyethylene-based polymers, aramid-based polymers, nylon-based polymers, cellulose-based polymers, polyethylene terephthalate, polyvinyl alcohol, polycarbonate, polypropylene, polyamic acid, polyimide, polyvinylidene fluoride, polyacrylonitrile, polystyrene, polyvinyl chloride, and combinations thereof.

Thereafter, after electrodes (copper plates) were attached to both ends of the MXene composite fibers (i.e., heating wires), thermal properties of the MXene composite fibers were measured.

### Test Example 4: Evaluation of Resistance of MXene Composite Fibers

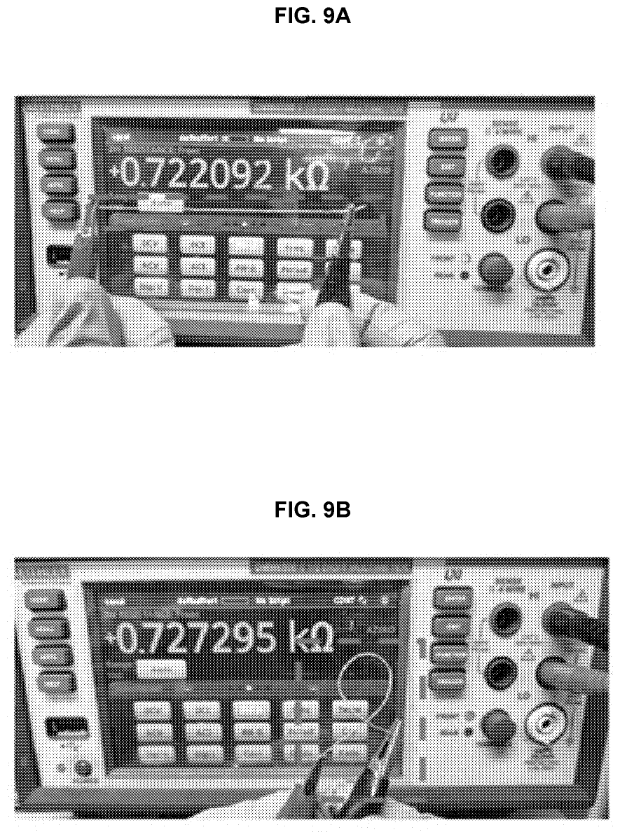

FIG. 9A is a photograph showing resistance of the MXene composite fibers before bending. FIG. 9B is a photograph showing resistance of the MXene composite fibers after bending.

As shown in FIGS. 9A and 9B, there was no change in the resistance of the MXene composite fibers before and after bending.

### Test Example 5: Evaluation of Heat Resistances of MXene Composite Fibers

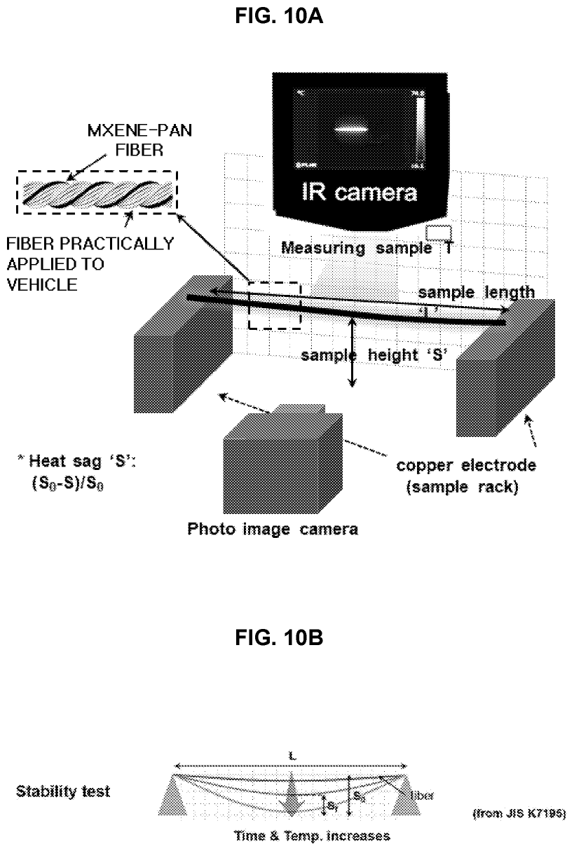

FIG. 10A is a view schematically showing an apparatus for measuring stabilities of the MXene composite fibers. FIG. 10B is a view showing a method of measuring the stabilities of the MXene composite fibers.

The stability of the MXene composite fibers was measured using the apparatus shown in FIG. 10A.

As shown in FIG. 10B, the stability was measured using a degree of sagging of the MXene composite fibers in case of generating heat. The method of measuring the stability of the MXene composite fibers was designed based on JIS K7195 (Testing method for heat sag of plastics), and the degree of sagging of the MXene composite fibers for a designated time was measured by Equation 1 below.

Degree of sagging (%)=(Sₒ−S_{f})/L [Equation 1]

It was determined, when the degree of sagging of the MXene composite fibers is less than 10% at an operating temperature of about 60 °C for 24 hours, the MXene composite fibers are a good product.

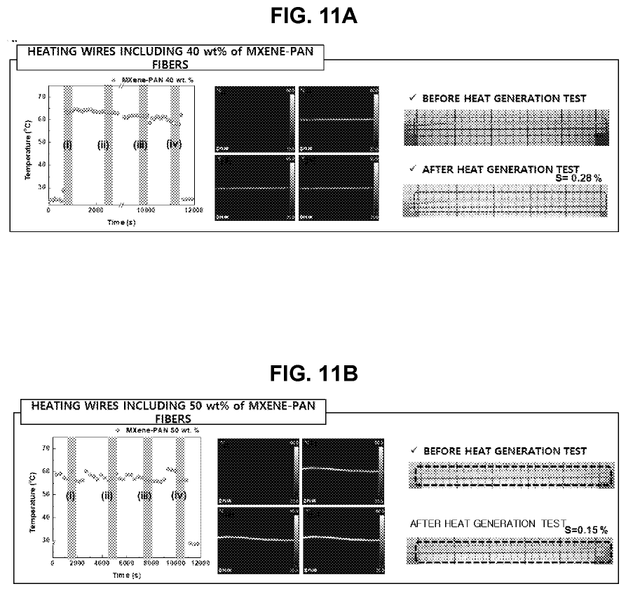

FIGS. 11A and 11B are views showing results of heat resistance evaluation of the MXene composite fibers (heating wires). The MXene composite fibers (heating wires) shown in FIG. 11A were obtained by braiding the MXene-PAN fibers including 40 wt % of MXene with the polymer fibers. Further, the MXene composite fibers (heating wires) shown in FIG. 11B were obtained by braiding the MXene-PAN fibers including 50 wt % of MXene with the polymer fibers.

As shown in FIGS. 11A and 11B, seeing that the degrees of sagging of the MXene composition fibers according to an exemplary embodiment of the present disclosure were measured to be 0.15 to 0.28, no sagging of the fibers was observed.

Further, it may be confirmed that the MXene composite fibers according to an exemplary embodiment of the present disclosure maintained heat generation performance in a heat generation test continuously performed for 3 hours.

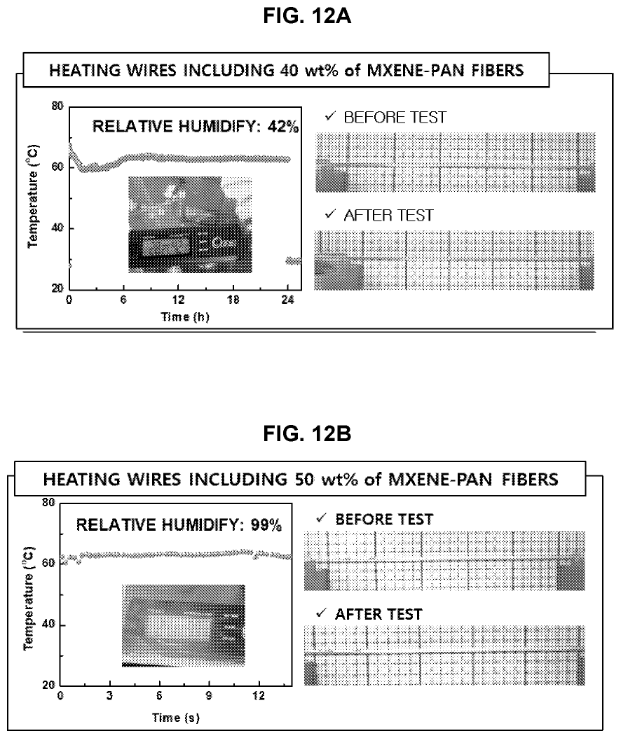

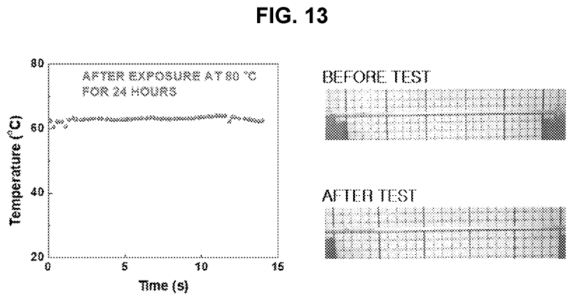

FIGS. 12A and 12B are views showing results of heat resistance evaluation of the MXene composite fibers (heating wires) depending on humidity. The MXene composite fibers (heating wires) shown in FIG. 12A were obtained by braiding the MXene-PAN fibers including 40 wt % of MXene with the polymer fibers. Here, the heat resistance of the MXene composite fibers was evaluated at an operating temperature of about 60 °C by applying current of 15 V cm⁻¹ at a relative humidity (RH, in air) of 42% for 24 hours.

Further, the MXene composite fibers (heating wires) shown in FIG. 12B were obtained by braiding the MXene-PAN fibers including 50 wt % of MXene with the polymer fibers. Here, the heat resistance of the MXene composite fibers was evaluated at an operating temperature of about 60 °C by applying current of 15 V cm⁻¹ at a relative humidity (RH, in air) of 99% for 24 hours.

As shown in FIGS. 12A and 12B, no sagging of the MXene composite fibers according to an exemplary embodiment of the present disclosure depending on heat generation temperature changes during the test or before and after the test was observed, and thus, the MXene composite fibers according to the present disclosure have excellent stability in heat generation and excellent heat resistance depending on humidity.

FIG. 13 is a view showing results of heat resistance evaluation of the MXene composite fibers (heating wires) with respect to a high temperature. The MXene composite fibers (heating wires) shown in FIG. 13 were obtained by braiding the MXene-PAN fibers including 50 wt % of MXene with the polymer fibers. Here, after the MXene composite fibers (heating wires) were put into a chamber set to a temperature of 80 °C, the heat resistance performance of the MXene composite fibers (heating wires) was evaluated for 24 hours.

As shown in FIG. 13, the MXene composite fibers according to the present disclosure had excellent stability in heat generation with respect to high external temperature change. Further, no sagging of the MXene composite fibers was observed before and after the test.

Therefore, the MXene composite fibers according to the present disclosure had excellent heat resistance to an external temperature.

Accordingly, the MXene composite fibers according to an exemplary embodiment of the present disclosure can be manufactured by braiding the MXene-PAN fibers heat-treated at a specific temperature with the polymer fibers, and may thus have greatly improved mechanical properties and oxidation stability, and improve both electrical conductivity and mechanical properties at the same time.

Further, the MXene composite fibers according to an exemplary embodiment of the present disclosure exhibit high heat generation efficiency due to low thermal conductivity thereof, and have stable properties with respect to external mechanical force (tension, torsion, bending, and the like).

Moreover, the MXene composite fibers according to an exemplary embodiment of the present disclosure may perform stable exothermic behavior without sagging even at a high temperature and a continuously applied voltage, and thus, a device and a wearable product, to which the MXene composite fibers are applied, may secure lifespan enhancement and high stability.

As is apparent from the above description, MXene composite fibers according to various exemplary embodiments of the present disclosure can be manufactured by braiding MXene-PAN fibers heat-treated at a specific temperature with polymer fibers, and may thus have greatly improved mechanical properties and oxidation stability, and improve both electrical conductivity and mechanical properties at the same time.

The disclosure has been described in detail with reference to exemplary embodiments thereof. However, it will be appreciated by those skilled in the art that changes may be made in these embodiments without departing from the principles and spirit of the disclosure, the scope of which is defined in the appended claims and their equivalents.

1. A method of manufacturing a composite fiber, comprising:
preparing a first dispersion comprising an MXene compound and a first solvent, wherein the MXene compound is represented by Formula (I)
Mₙ₊₁XₙTₓ (I)
wherein M is an early transition metal, X is C or N, Tₓ is a surface termination, and n is an integer of 1 to 4;
preparing a second dispersion comprising polyacrylonitrile (PAN) and a second solvent;
obtaining an admixture comprising the first dispersion and the second dispersion;
obtaining MXene-PAN fiber using the admixture; and
obtaining the composite fiber that comprises the MXene-PAN fiber and polymer fiber,
wherein an electrical conductivity of the MXene-PAN fiber is about 0.1 Scm⁻¹ to 1,000 Scm⁻¹.

2. The method of claim 1 wherein a spun fiber is obtained by performing wet-spinning of the admixture; and/or a MXene-PAN fiber is obtained by performing heat treatment of the spun fibers; and/or the composite fiber is obtained by braiding the MXene-PAN fiber with a polymer fiber

3. The method of claim 1, wherein the first solvent comprises one or more selected from the group consisting of 1-methyl-2-pyrrolidinone-N-methyl-2-pyrrolidinone (NMP), N,N-dimethylformamide (DMF), dimethylacetamide (DMAc), dimethyl sulfoxide (DMSO).

4. The method of claim 1, wherein a concentration of the MXene compound in the first dispersion is about 10 mg/mL to 45 mg/mL.

5. The method of claim 1, wherein the second solvent comprises one or more selected from the group consisting of 1-methyl-2-pyrrolidinone-N-methyl-2-pyrrolidinone (NMP), N,N-dimethylformamide (DMF), dimethylacetamide (DMAc), and dimethyl sulfoxide (DMSO).

6. The method of claim 1, wherein a concentration of the PAN in the second dispersion is about 50 mg/mL to 500 mg/mL.

7. The method of claim 2, wherein the spun fibers comprises an amount of about 10 wt % to 50 wt % of the MXene compound based on a total weight of the spun fibers.

8. The method of claim 2, wherein, in obtaining the spun fibers, the spun fibers are obtained by wet-spinning the admixture into a coagulation solution,
wherein the coagulation solution comprises one or more selected from the group consisting of water, acetone, methyl alcohol, ethyl alcohol, isopropyl alcohol, methyl acetate, ethyl acetate, propyl acetate, acetic acid, acetonitrile, 1-methyl-2-pyrrolidinone-N-methyl-2-pyrrolidinone (NMP), N,N-dimethylformamide (DMF), dimethylacetamide (DMAc), dimethyl sulfoxide (DMSO), and tetrahydrofuran (THF).

9. The method of claim 8, wherein a temperature of the coagulation solution is about 20 °C to 60 °C.

10. The method of claim 1, wherein the wet-spinning is performed using a spinneret having a diameter of about 10 μm to 1,500 μm.

11. The method of claim 1, wherein the heat treatment is performed at a temperature of about 300 °C to 500 °C.

12. The method of claim 1, wherein the heat treatment is performed at a heating rate of about 1 to 20 °C min⁻¹ for about 30 to 90 minutes.

13. The method of claim 1, wherein:
the MXene-PAN fiber has a fiber structure comprising a base material comprising the PAN and the MXene compound is distributed in the base material; and
the MXene-PAN fiber comprises an amount of about 10 wt % to 50 wt % of the MXene compound based on a total weight of the MXene-PAN fiber.

14. The method of claim 1, wherein the polymer fiber comprises one or more selected from the group consisting of polyethylene-based polymers, aramid-based polymers, nylon-based polymers, cellulose-based polymers, polyethylene terephthalate, polyvinyl alcohol, polycarbonate, polypropylene, polyamic acid, polyimide, polyvinylidene fluoride, polyacrylonitrile, polystyrene, and polyvinyl chloride.

15-20. (canceled)
